(19) United States
(12) Patent Application Publication
(10) Pub. No.: US 2020/0300034 A1
(43) Pub. Date: Sep. 24, 2020

(54) A ROLLER BLIND MOUNTING SYSTEM

(71) Applicant: SILENT SHADE PTY LTD, Ashmore, Queensland (AU)

(72) Inventor: Tony HOPKINS, Ashmore, Queensland (AU)

(21) Appl. No.: 16/087,499

(22) PCT Filed: Mar. 22, 2017
(86) PCT No.: PCT/AU2017/050258

§ 371 Date: Sep. 21, 2018

(30) Foreign Application Priority Data
Mar. 23, 2016 (AU) 2016901084
Mar. 23, 2016 (AU) 2016901086

(51) Int. Cl. E06B 9/58; E06B 9/42

(52) U.S. Cl. CPC E06B 9/58; E06B 2009/587; E06B 2009/583; E06B 9/42

(57) ABSTRACT

A roller blind mounting system 1 including: at least one bracket 3 for mounting a roller blind 5. The roller blind 5 including a retractable blind fabric 7. The system further including at least one guide line 9 for guiding travel of the blind fabric 7 during winding and unwinding of the blind fabric 7. The guide line including a first end connectable to the bracket 3 and a second opposite end connectable to a fixed surface, wherein the bracket 3 includes a tensioning device 15 for selectively tensioning the guide line 9.

### FIELD OF THE INVENTION

The present invention is directed to a roller blind mounting system for a roller blind. The invention is particularly suited for mounting a roller blind to the exterior of a building structure and will therefore be described with reference to this type of application.

### BACKGROUND TO THE INVENTION

Roller blinds are a form of window covering which typically consist of an elongate tubular member upon which a blind fabric is wound. The blind fabric is usually deployed vertically, for example in close proximity to an external window surface or open area in a side of a building structure. Roller blinds are usually mounted at opposing ends of the tubular member to a fixed surface of the building structure. In this respect each end of the tubular member is attached to a corresponding mounting bracket that is fastened to the fixed surface of the building structure. In order to guide travel as the blind fabric is rolled or unrolled, both vertical side edges of the blind fabric have a corresponding guide cable provided in close proximity. The guide cables extend downwardly from or adjacent to the mounting brackets and are anchored at a lower free end to a fixed surface below the roller blind, for example a side wall of the building or an underlying floor, deck or ground surface. In this respect, the guide cables are anchored at the lower end under tension such that the guide cables are taut after anchoring. Anchoring of the guide cables typically involves some form of crimping sleeve being secured at the ends of the guide cables. Prior to anchoring, a rail secured to a lower edge of the blind fabric is placed on the guide cables. The rail is confined to travel along the guide cables as the blind fabric is rolled and unrolled.

A problem with known roller blind mounting systems is that tensioning of the guide cables can be difficult, labour intensive and time consuming to complete. Further, in some instances maintenance or replacement of a guide cable requires both blind mounting brackets and the roller blind to be removed in order to gain access to the anchoring points of the guide cable. It can also be difficult to mount a roller blind in a precisely level orientation without altering the mounting location of the mounting brackets.

It would be desirable to provide a roller blind mounting system that overcomes at least one of the disadvantages of the prior art.

Any discussion of documents, devices, acts or knowledge in this specification is included to explain the context of the invention. It should not be taken as an admission that any of the material formed part of the prior art base or the common general knowledge in the relevant art on or before the priority date of the claims herein.

### SUMMARY OF THE INVENTION

In accordance with the present invention, there is provided a roller blind mounting system including:

at least one bracket for mounting a roller blind to a fixed surface, the roller blind including a retractable blind fabric, and

at least one guide line for guiding travel of the blind fabric during winding and unwinding of the blind fabric, the guide line including a first end connectable to the bracket and a second opposite end connectable to a fixed surface,

wherein the bracket includes a tensioning device for selectively tensioning the guide line.

By providing the mounting bracket with a tensioning device, a lower (second) end of the guide line is advantageously able to be anchored and secured to a fixed surface below the roller blind, for example a side wall of the building or an underlying floor, deck or ground surface, prior to the guide line being tensioned. As a result the anchoring process is much easier as the guide line can be secured, for example with a crimping sleeve, without requiring the guide line to be held taut by the installer. In addition, the tensioning device on the bracket advantageously avoids the need for cumbersome adjustments to be made at the lower end of the guide line.

The tensioning device of the bracket preferably includes a base member and a slide member moveable relative to the base member. In this regard movement of the slide member with respect to the base member is preferably guided by the base member. For example by opposing arms of the base member within which the slide member is held. The first (upper) end of the guide line is preferably retained by the slide member. The tensioning device may further include an adjustment member for altering the position of the slide member with respect to the base member to thereby selectively tension the guide line.

The adjustment member may be in the form of a threaded stem mounted within a threaded aperture in the base member. A free end of the threaded stem preferably acts upon the slide member to tension the guide line.

In one embodiment, the free end of the threaded stem acts upon a leg portion of the slide member. In this regard, the leg portion is preferably configured to bend if excessive tension is applied to the guide line. This advantageously releases tension within the guide line thereby minimising potential damage to the roller blind in excessively windy conditions by allowing the blind fabric the ability to be slightly displaced away from its normal vertical operating plane.

The bracket of the roller blind mounting system may further include a levelling cradle for supporting one end of the roller blind. The levelling cradle preferably includes a main body and a support element having a seat for holding one end of the roller blind. The support element is preferably at least partly housed within the main body. The levelling cradle may further include an adjustment device for adjusting the position of the support element with respect to the main body to thereby alter the position of the roller blind.

The adjustment device may include at least one threaded pin engaged in a corresponding threaded aperture provided in the main body. The threaded pin can be positioned in abutment with the support element such that the position of the support element with respect to the main body is adjusted by turning the threaded pin. In a particularly preferred embodiment, the adjustment device includes a pair of threaded pins engaged in corresponding threaded apertures provided in the main body. In this regard, one of said threaded pair of pins provides vertical adjustment of the support element, and the other of said pair of pins provides horizontal adjustment of the support element.

The bracket of the roller blind mounting system preferably includes a base plate for mounting the bracket to a support structure. The base plate preferably includes a series of mounting holes configured to enable the bracket to be selectively mounted to a horizontal or vertical fixed surface of the support structure. The base plate may further include a plurality of openings for mounting the levelling cradle and the tensioning device. In this regard, the plurality of openings are preferably configured to enable the levelling device and tensioning device to be orientated and mounted in a selected number of positions on the base plate. This advantageously provides multiple mounting configurations including the mounting of the bracket to an overhead surface, side surface or rear surface of a surrounding support structure.

Further, the levelling cradle advantageously enables the roller blind position to be altered such that the blind can be made level without having to alter the mounting of the bracket's base plate on the support structure.

The roller blind mounting system may further include a rail for attaching to a bottom edge of the retractable blind fabric. The rail includes at least one guide channel into which the guide line may be accommodated to constrain the rail to movement along the guide line and thereby guide travel of the blind fabric when winding and unwinding between extended and retracted positions.

The roller blind mounting system may further include at least one mounting block assembly for securing the second or lower end of the guide line to the fixed surface. The mounting block assembly preferably includes a docking platform for the rail, wherein at least a portion of the rail abuts with the docking platform when the retractable blind fabric is in a fully extended unwound position.

The roller blind mounting system may further include at least one magnetic assembly for holding the rail in abutment with the docking platform. The magnetic assembly may include a magnetic member and the docking platform may be made of a material which is magnetically attracted to the magnetic member such that in use, the rail can be held in abutment with the docking platform by a magnetic force between the docking platform and the magnetic member. The magnetic member is preferably at least in part housed within a cavity of the rail. The magnetic assembly may further include a biasing member operatively connected to the magnetic member for biasing the magnetic member into the cavity.

There is also provided in another aspect of the invention, a roller blind mounting system including at least one bracket for mounting a roller blind to a fixed surface, wherein the bracket includes a levelling cradle for supporting one end of roller blind, the levelling cradle includes a main body and a support element having a seat for holding said one end of the roller blind, the support element being at least partially housed by the main body, the levelling cradle further including an adjustment device for adjusting the position of the support element with respect to the main body to thereby alter the position of the roller blind.

There is also provided in another aspect of the invention, a roller blind mounting system including at least one bracket for mounting a roller blind, wherein the bracket includes a base plate for mounting the bracket to a fixed surface of a support structure, the base plate including a series of mounting holes configured to enable the bracket to be selectively mounted to a horizontal or vertical fixed surface of the support structure.

There is also provided in another aspect of the invention, a roller blind mounting system including:

at least one bracket for mounting a roller blind having a retractable blind fabric;
at least one guide line for guiding travel of the blind fabric during winding and unwinding of the blind fabric, the guide line including a first end connectable to the bracket and a second opposite end, and
at least one mounting block assembly for securing the second end of the guide line to a fixed surface.

There is also provided in another aspect of the invention, a roller blind mounting system including:

at least one bracket for mounting a roller blind having a retractable blind fabric;
at least one guide line for guiding travel of the blind fabric during winding and unwinding of the blind fabric, the guide line including a first end connectable to the bracket and a second opposite end for securing to a fixed surface;
a rail for attaching to a bottom edge of the retractable blind fabric, the rail being constrained for movement along the guide line to thereby guide travel of the blind fabric between a fully extended position and a retracted position, and
at least one magnetic assembly for holding the rail when the blind fabric is in the fully extended position.

### BRIEF DESCRIPTION OF THE DRAWINGS

It will be convenient to further describe the invention with respect to the accompanying drawings which illustrate preferred embodiments of the roller blind mounting system according to the present invention. Other embodiments of the invention are possible, and consequently, the particularity of the accompanying drawings is not to be understood as superseding the generality of the preceding description of the invention. The preferred embodiments will be described with reference to the following figures in which:

FIG. 1 is a front view of a vertical drop roller blind attached to a roller blind mounting system according to an embodiment of the invention;

FIG. 2 is a perspective view of a bracket of the roller blind mounting system illustrated in FIG. 1;

FIG. 3a is a perspective view of the bracket illustrated in FIG. 2 without the levelling cradle;

FIG. 3b is a side view of the bracket illustrated in FIG. 3a with the tensioning device adjusted to provide minimal tensioning of the guide line;

FIG. 3c is a side view of the bracket illustrated in FIG. 3a with the tensioning device adjusted to provide increased tensioning of the guide line;

FIG. 4a is a perspective view of the bracket illustrated in FIG. 2 without the tensioning device;

FIG. 4b is a side view of the bracket illustrated in FIG. 4a with the levelling cradle positioned in a lowest most position;

FIG. 4c is a side view of the bracket illustrated in FIG. 4a with the levelling cradle in a highest most position;

FIG. 5a is a detailed view of one end of the rail of the mounting system being held to the mounting block assembly via a magnetic member;

FIG. 5b is a detailed view of one end of the rail in abutment with the mounting block assembly with the magnetic member retracted:

FIG. 6a is a detailed view of one end of the rail on the guide line, the guide line being secured by a mounting block assembly configured for fastening to a masonry surface in accordance with one embodiment of the invention;

FIG. 6b is an exploded view showing various components of the mounting block assembly shown in FIG. 6a;

FIG. 7a is a detailed view of one end of the rail on the guide line, the guide line being secured by a mounting block assembly configured for fastening to a timber surface in accordance with another embodiment of the invention;

FIG. 7b is an exploded view showing various components of the mounting block assembly shown in FIG. 7a;

FIG. 8a is a detailed view of one end of the rail on the guide line, the guide line being secured by a mounting block assembly configured for fastening to a vertical surface in accordance with another embodiment of the invention, and

FIG. 8b is an exploded view showing various components of the mounting block assembly shown in FIG. 8a.

### DESCRIPTION OF THE PREFERRED EMBODIMENTS

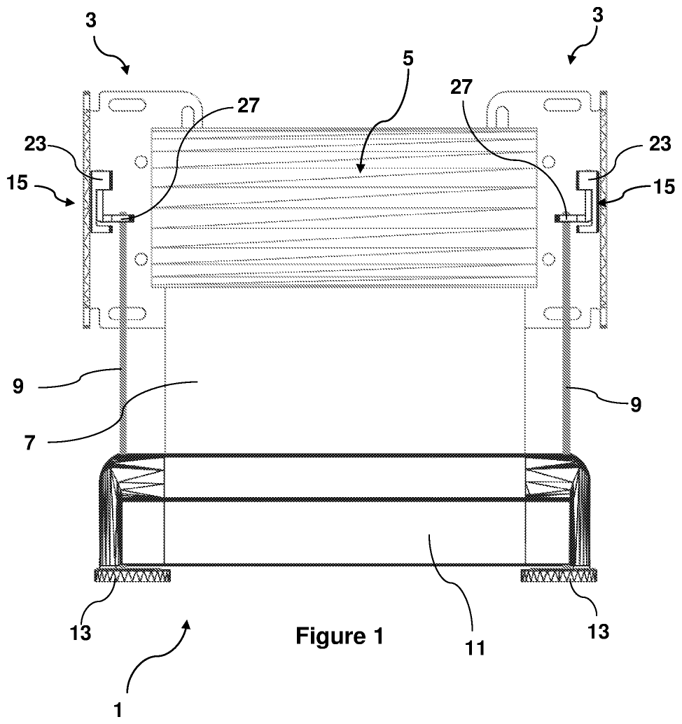

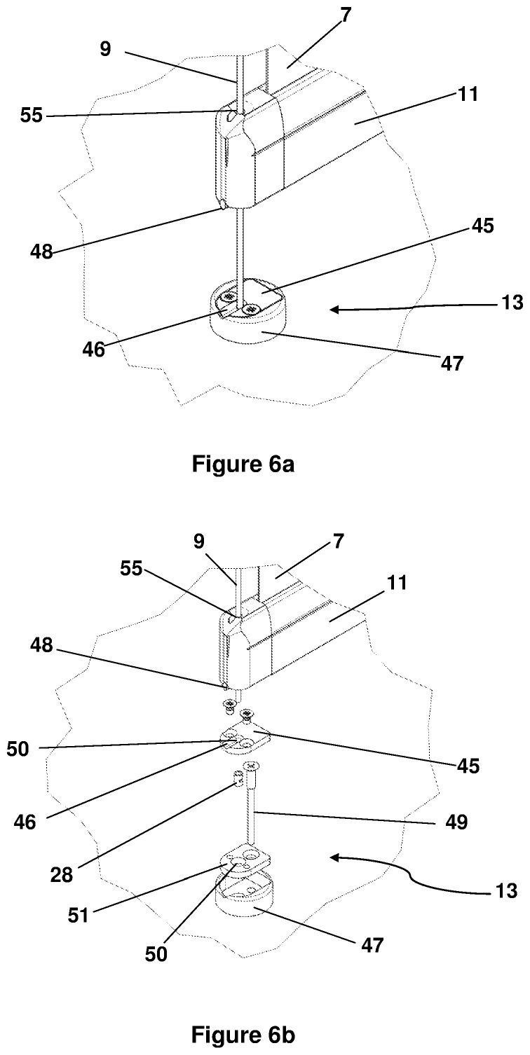

Referring to FIG. 1 initially, there is shown various components of a roller blind mounting system 1 according to an embodiment of the invention. The roller blind mounting system 1 illustrated in FIG. 1 includes a pair of brackets 3 supporting opposite ends of a roller blind 5 having a retractable blind fabric 7. The system 1 is designed to support roller blinds 5 of widths of up to 6.5 m. The mounting system 1 shown includes a pair of guide lines 9 (which may be in the form of guide cables), each having a first (upper) end connected to a corresponding bracket 3 and a second opposite (lower) end secured by a mounting block assembly 13 to a fixed surface. The guide lines 9 function to guide travel of the blind fabric 7 when the blind 5 is being rolled up and down. In this respect, the mounting system 1 further includes a rail 11 mounted along a bottom edge of the blind fabric 7. The rail 11 is restricted to travel along the guide lines 9. In this regard, as best shown in FIGS. 6a to 8b, each end of the rail 11 includes a guide channel 55 which accommodates a guide line 9 to constrain the rail 11 to movement along the guide lines 9. When the blind 5 is in a fully extended position the rail 11 at a bottom edge of the blind fabric 7 abuts with the mounting block assembly 13. The rail 11 disengages with the mounting block assembly 13 and travels up the guide lines 9 when the blind fabric 7 is retracted and wound back onto a roller (not shown) of the roller blind 5.

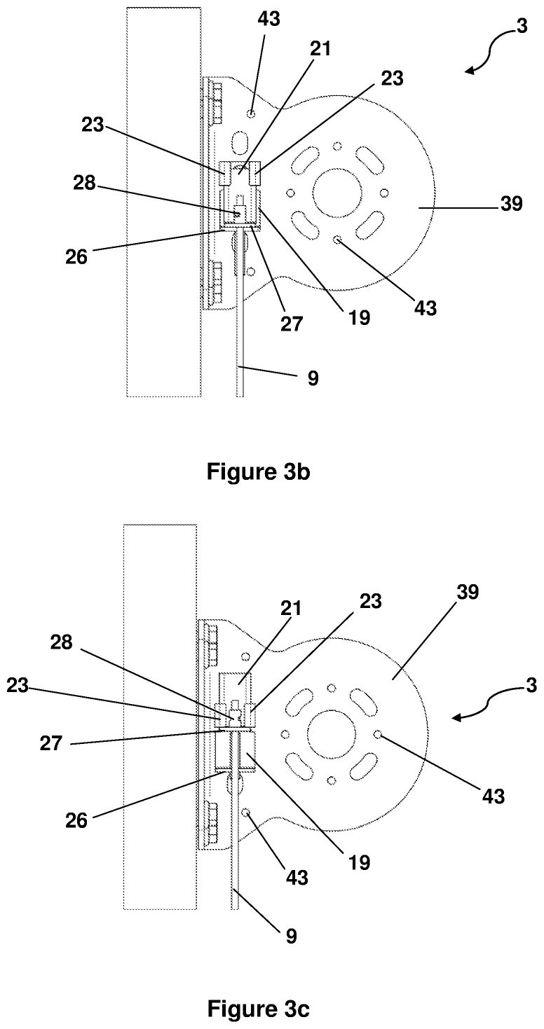

Each bracket 3 further includes a tensioning device 15 for tensioning the guide line 9 and a levelling cradle 17 for supporting an end of the roller blind 5. Each tensioning device 15 includes a base member 19 and a slide member 21 which is movable with respect to the base member 19. In this respect, the slide member 21 is held and guided for movement vertically within opposing arms 23 of the base member 19. The tensioning device 15 further includes an adjustment member 25 having a threaded stem, for altering the vertical position of the slide member 21 with respect to the base member 19. With reference to FIG. 3a, the base member 19 includes an outwardly projecting foot 26 having a threaded aperture therein. The threaded stem of the adjustment member 25 being located within the threaded aperture in the base member 19. The slide member 21 of the tensioning device 15 includes an outwardly projecting leg portion 27 which lies substantially parallel to the foot 26 of the base member 19. The leg portion 27 includes a fastening hole through which the guide line 9 passes when securing the guide line 9 to the bracket 3. In this respect, after passing through the fastening hole the upper free end of the guide line 9 is with provided with a crimping sleeve 28 to prevent the end of guide line 9 withdrawing from the aperture in the leg portion 27.

The threaded stem of the adjustment member 25 acts upon the leg portion 27 by a free end of the threaded stem abutting with an underside of the leg portion 27. By rotation of the threaded stem the slide member 21 can be moved vertically to alter the tension provided in the guide line 9. The slide member 21 can be adjusted between a fully lowered position shown in FIG. 3b, in which the leg portion 27 is in abutment with the projecting foot 26 of the base member 19, to a fully raised position as shown in FIG. 3c in which the leg portion 27 is spaced from the projecting foot 26 of the base member 19. When the leg portion 27 is raised to a position providing the desired tension to the guide line 9, the leg portion 27 may be locked in place with a lock nut. If the leg portion 27 is raised to a position whereby excessive tension is applied to the guide line 9, the leg portion 27 is able to bend downwardly to reduce tension.

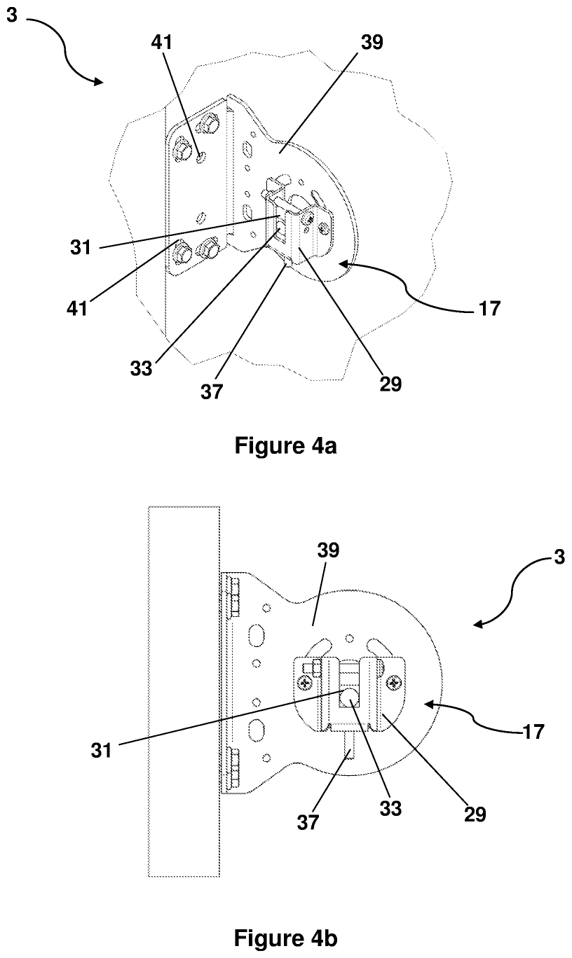

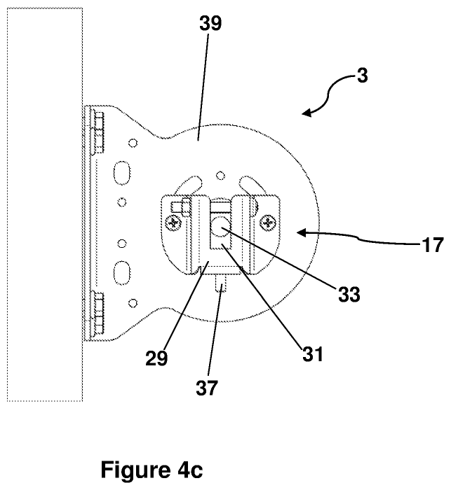

With reference to FIGS. 4a to 4c, the levelling cradle 17 of each bracket 3 includes a main body 29 having a substantially U-shaped configuration and a support element 31 at least partially housed within the main body 29. The support element 31 includes a seat 33 for holding one end of the roller blind 5. The levelling cradle 17 further includes an adjustment device for altering the position of the support element 31 with respect to the main body 29. The adjustment device includes a threaded pin 37 engaged in a corresponding threaded aperture provided in an underside of the main body 29. The threaded pin 37 has a free end in abutment with the support element 31 such that the vertical position of the support element with respect to the main body 29 is adjusted by turning the thread pin 37 in this regard, the threaded pin 37 can be turned to move the support element vertically between a fully lowered position, as shown in FIG. 4b and a fully raised position as shown in FIG. 4c. The roller blind 5 mounted between two brackets 3 is thereby able to be levelled by adjustment of each bracket's threaded pin 37. The levelling cradle 17 advantageously provides vertical adjustment of up to about 10 mm at both ends of the roller blind 5. The adjustment assists with difficult installations where it may be hard to align the brackets 3. Fine adjustment is also possible for ensuring the blind fabric 7 is running square. Fine adjustment of the levelling cradle 17 is also useful for fine adjustment of the roller blind 5 limits for best possible tensioning of the blind fabric 7. In a further embodiment not illustrated, an additional threaded pin engaged in a corresponding threaded aperture provided in a side wall of the main body 29 provides horizontal adjustment of the support element 31 with respect to the main body 29.

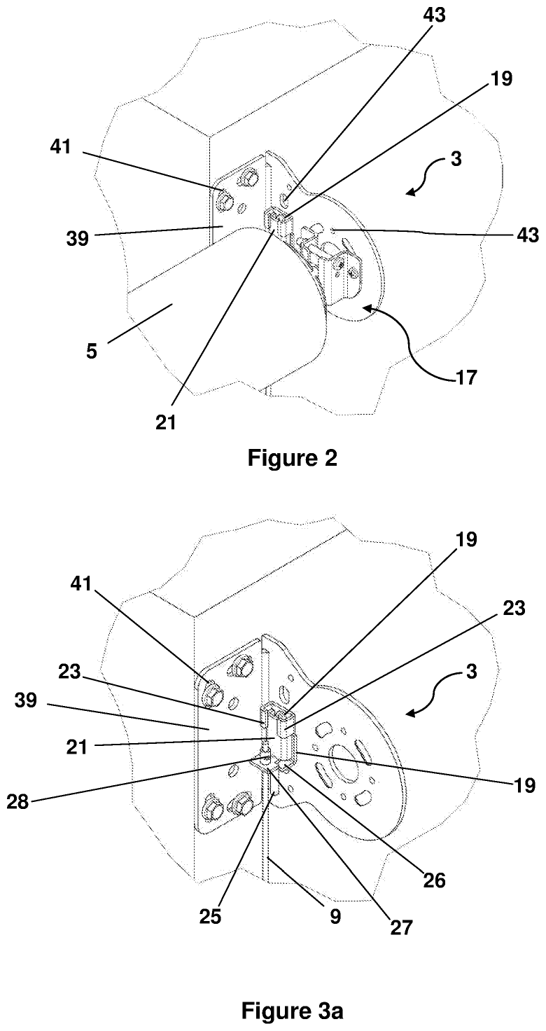

Each bracket 3 further includes a base plate 39 for mounting the bracket 3 to a support structure. The base plate 39 is generally of L-shaped configuration and includes a series of mounting holes 41 arranged to enable the bracket 3 to be selectively mounted to a side wall, overhead wall or rear wall (as illustrated in FIGS. 2-4c) of a support structure for example, a window frame. As best shown in FIGS. 3a to 3c, the base plate 39 further includes a plurality of openings 43 for mounting the levelling cradle 17 and tensioning device 15. This enables the levelling cradle 17 and tensioning device 15 to be oriented and mounted in a selected number of different positions on the base plate 39 depending upon the mounting orientation of the bracket 3 with respect to the support structure. For example when the bracket 3 is to be mounted to an overhead wall, the mounting orientation of the levelling cradle 17 with respect to the base plate 39 is moved anticlockwise by 90° to that depicted in FIGS. 4a to 4C. Likewise, the mounting orientation tensioning device 15 with respect to the base plate 39 is moved anticlockwise by 90° to that depicted in FIGS. 2 to 3C. The tensioning device 15 and levelling cradle 17 are intended to be mounted from the inside of the bracket 3 on the base plate 39. This advantageously allows any maintenance or future adjustments to be made without the need to remove the base plate 39 of the bracket 3 from the support structure. This is particularly advantageous when installing roller blinds side by side or replacing guide lines 9.

With reference to FIGS. 6a and 6b, a mounting block assembly 13 in accordance with one embodiment is illustrated which is suited for fastening to a fixed surface of masonry construction. The mounting block assembly 13 includes a cover plate 45 which functions as a docking platform for a bottom surface of the rail 11. In this respect, as mentioned previously, when the roller blind 5 is in a fully extended position the rail 11 at the bottom edge of the blind fabric 7 abuts with the mounting block assembly 13. The cover plate 45 includes an elongate groove or channel 46 into which a corresponding elongate protuberance 48 on an underside of the rail 11 seats when the roller blind 5 is fully extended. The mounting block assembly 13 illustrated in FIGS. 6a and 6b further includes a base cup 47 which is mounted on top of a masonry surface and secured in place with a masonry anchor 49. Positioned between the cover plate 45 and masonry anchor 49 is a fixing plate 51 which sits within a chamber formed in the base cup 47 and is secured in place with threaded fasteners. The second (lower end) of the guide line 9 passes through overlying guide line apertures 50 in the cover plate 45 and fixing plate 51 and is retained in the chamber space between the fixing plate 51 and base cup 47 with a crimping sleeve 28 which prevents the lower end of the guide line 9 being released from the mounting block assembly 13.

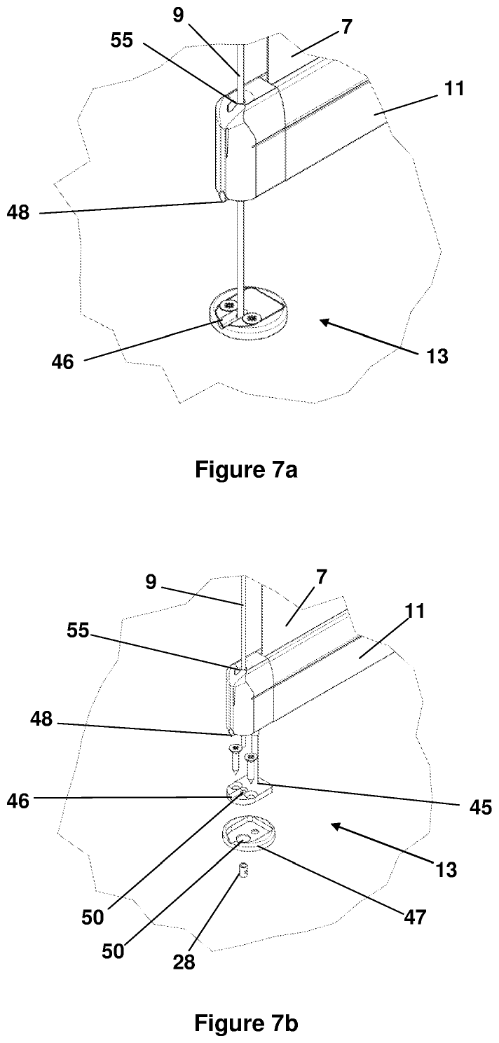

With reference to FIGS. 7a and 7b, a mounting block assembly 13 in accordance with a further embodiment is illustrated which is particularly suited for fastening the second (lower end) of the guide line 9 to a timber surface. The mounting block assembly 13 for timber surfaces includes a base cup 47 having a thickness of approximately 7 mm which is approximately half the thickness of the base cup 47 for masonry surfaces. Prior to securing the base cup 47 to the timber surface, a hole of approximately 6 mm is drilled into the timber surface in order to provide a chamber in which the second end of the guide line 9, and an associated crimping sleeve 28 applied to the end of the guide line 9, may be housed prior to the base cup 47 being screwed to the timber surface. The cover plate 45 is then positioned over the base cup 47.

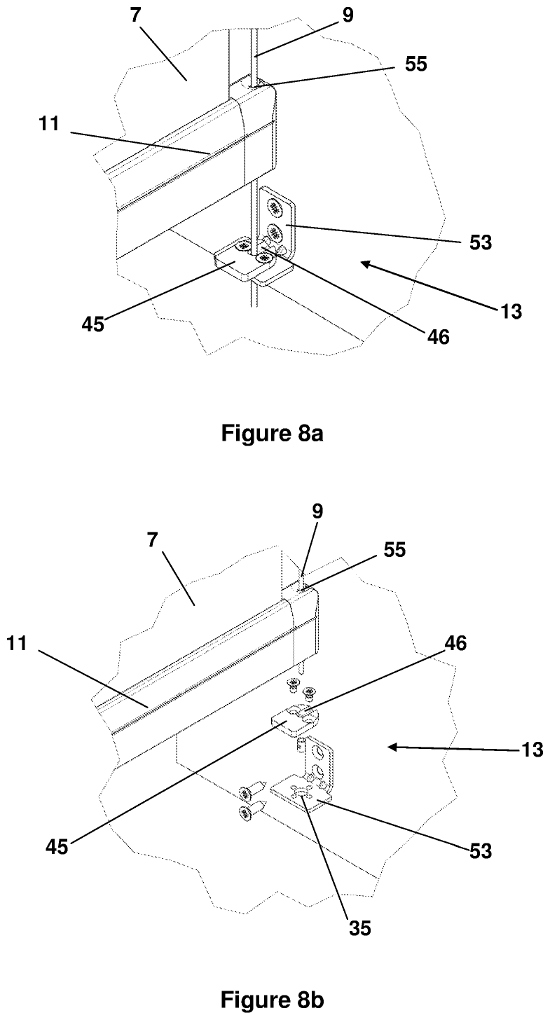

With reference to FIGS. 8a and 8b, a mounting block assembly 13 in accordance with a further embodiment is illustrated which is particularly suited for mounting the second (lower end) of the guide line 9 to a vertical surface. The mounting block assembly 13 in this particular embodiment includes a cover plate 45 which is substantially the same as the cover plate 45 used for timber and masonry surfaces. The mounting block assembly 13 in this embodiment includes an L-shaped fastening bracket 53, instead of a base cup and fixing plate, which is mounted to a vertical fixed surface with fasteners. A central aperture 35 is provided through the fastening bracket 53 with the second (lower end) of the guide line 9 being secured below the fastening bracket 53 with a crimping sleeve.

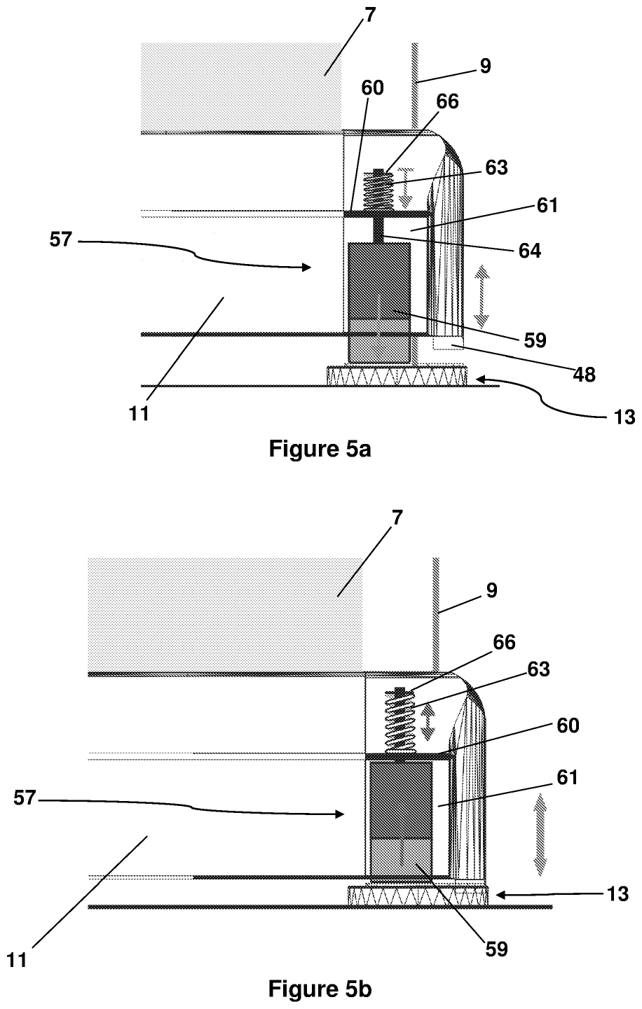

In order to maintain the rail 11 in contact with the mounting block assemblies 13, the roller blind mounting system 1 further includes at least one magnetic assembly 57. Preferably, a magnetic assembly 57 is provided at both ends of the rail 11. With reference to FIGS. 5a and 5b, the magnetic assembly 57 includes a magnetic member 59 which is housed within a cavity 61 in the rail 11. The magnetic assembly 57 further includes a biasing member 63 which may be in the form of a spring operatively connected to the magnetic member 59. The biasing member 63 is positioned to bias the magnetic member 59 into the cavity 61. In this regard, the biasing member 63 is located on a stem 64 projecting from the magnetic member 59. The stem 64 includes an end piece 66 which prevents removal of the biasing member 63 from the stem 64. The stem 64 extends through an opening in a top wall 60 of the cavity 61. One end of the biasing member 63 rests outside of the cavity 61 on the top wall 60 and an opposite end abuts with the end piece 66.

The cover plate 45 of the mounting block assembly 13 is made from a material which is magnetically attracted to the magnetic member 59. Accordingly, the magnet force between the magnetic member 59 and the cover plate 45 assist to maintain the rail 11 in contact with the mounting block assembly 13 in light winds. As wind strengthens, the force of the wind upon the blind fabric 7 may force the bottom end of the rail 11 to move away from the mounting block assembly 13 resulting in the biasing member 63 being compressed with the magnetic member 59 maintaining contact with the cover plate 45, as shown in FIG. 5a. If the wind subsides, the rail 11 is able to automatically return into abutment with the mounting block assembly 13, as shown in FIG. 5b, by the biasing member 63 forcing the magnetic member 59 into the cavity 61 which in turn results in the bottom end of the rail 11 reconnecting with the cover plate 45.

If the wind increases to sufficient strength to overcome the magnetic attraction between the magnetic member 59 and the cover plate 45, the rail 11 and associated blind fabric 7 will release from the mounting block assemblies 13. In such circumstances the roller blind 5 may be automatically retracted to protect the roller blind 5. In this regard, the roller blind 5 may be motorised and operatively connected to a wind sensor which measures the wind speed and automatically retracts the roller blind 5 if the wind speed reaches a predetermined speed.

A magnetic assembly 57 if preferably provided at each end of the rail 11 which enhances the weight of the rail 11 thereby assisting to keep the blind fabric 7 straight in light winds. In addition to a mounting block assembly 13 being provided at either side of the blind, an intermediate mounting block assembly (not shown) may be provided for roller blinds 5 which are extra wide. The magnetic hold down ability of the magnetic assemblies 57 advantageously enable tension to be maintained in the blind fabric 7 whilst still enabling the roller blind 7 to release and reattach if disturbed by light winds. In addition, the magnetic assemblies 57 advantageously enable a motorised roller blind 5 to overcome the magnetic force when desired and lift automatically to retract the blind 5. The retraction of the roller blind 5 may be controlled by associated wind sensors and/or automatic timers.

Modifications and variations as would be deemed obvious to the person skilled in the art are included within the ambit of the present invention as claimed in the appended claims.

1. A roller blind mounting system including:
at least one bracket for mounting a roller blind, the roller blind including a retractable blind fabric, and
at least one guide line for guiding travel of the blind fabric during winding and unwinding of the blind fabric, the guide line including a first end connectable to the bracket and a second opposite end connectable to a fixed surface,
the bracket including a tensioning device for selectively tensioning the guide line, the tensioning device including a slide member retaining a first end of the guide line,
wherein the tensioning device further includes an adjustment member for altering the position of the slide member with respect to a base member of the tensioning device, to thereby selectively tension the guide line.

2. (canceled)

3. A roller blind mounting system as claimed in claim 1 wherein the adjustment member is a threaded stem mounted within a threaded aperture in the base member, a free end of the threaded stem acting upon the slide member to tension the guide line.

4. A roller blind mounting system as claimed in claim 3 wherein the free end of the threaded stem acts upon a leg portion of the slide member, the leg portion being configured to bend if excessive tension is applied to the guide line.

5. A roller blind mounting system as claimed in claim 1 wherein the bracket further includes a levelling cradle for supporting one end of roller blind, the levelling cradle includes a main body and a support element having a seat for holding said one end of the roller blind, the support element being at least partially housed by the main body, the levelling cradle further including an adjustment device for adjusting the position of the support element with respect to the main body to thereby alter the position of the roller blind.

6. A roller blind mounting system as claimed in claim 5 wherein the adjustment device includes at least one threaded pin engaged in a corresponding threaded aperture provided in the main body, said threaded pin being in abutment with the support element such that the position of the support element with respect to the main body is adjusted by turning the threaded pin.

7. A roller blind mounting system as claimed in claim 6 wherein the adjustment device includes a pair of said threaded pins engaged in corresponding threaded apertures provided in the main body, one of said pair of threaded pins providing vertical adjustment of said support element, and the other of said pair of threaded pins providing horizontal adjustment of said support element.

8. A roller blind mounting system as claimed in claim 1 wherein the bracket includes a base plate for mounting the bracket to a support structure, the base plate including a series of mounting holes configured to enable the bracket to be selectively mounted to a horizontal or vertical surface of the support structure.

9. A roller blind mounting system as claimed in claim 8 wherein the base plate further includes a plurality of openings for mounting the levelling cradle and the tensioning device, the openings being configured to enable the levelling cradle and the tensioning device to be orientated and mounted in a selected number of positions on the base plate.

10. A roller blind mounting system as claimed in qclaim 1, further including a rail for attaching to a bottom edge of the retractable blind fabric, the rail including at least one guide channel, the guide line being accommodated in the channel to constrain the rail to movement along the guide line and thereby guide travel of the blind fabric between the extended and retracted positions.

11. A roller blind mounting system as claimed in claim 10 further including a mounting block assembly for securing the second end of the guide line to the fixed surface, the mounting block assembly including a docking platform for the rail, wherein at least a portion of the rail abuts with the docking platform when the retractable blind fabric is in the extended position.

12. A roller blind mounting system as claimed in claim 11 further including at least one magnetic assembly for holding the rail in abutment with the docking platform, the magnetic assembly includes a magnetic member and the docking platform is made of a material which is magnetically attracted to the magnetic member, wherein in use, the rail is held in abutment with the docking platform by magnetic force between the docking platform and the magnetic member.

13. A roller blind mounting system as claimed in claim 12 wherein in use, the magnetic member abuts with the docking platform to hold the rail in abutment with the docking platform, and wherein the magnetic member is at least in part housed within a cavity of the rail, the at least one magnetic assembly further including a biasing member operatively connected to the magnetic member for biasing the magnetic member into the cavity.
